(19) United States
(12) Patent Application Publication
(10) Pub. No.: US 2007/0254976 A1
(43) Pub. Date: Nov. 1, 2007

(54) Method For Production Of Cement Dispersant And Polycarboxylic Acid Type Polymer For Cement Dispersant

(75) Inventors: Tsuyoshi Hirata, Kobe-shi (JP); Hirokatsu Kawakami, Izumiotsu-shi (JP)

Correspondence Address: BUCHANAN, INGERSOLL & ROONEY PC, POST OFFICE BOX 1404, ALEXANDRIA, VA, 22313-1404, US

(73) Assignee: NIPPON SHOKUBAI CO., LTD., Osaka-shi, Osaka (JP)

(21) Appl. No.: 11/631,694

(22) PCT Filed: Jul. 11, 2005
(86) PCT No.: PCT/JP05/13202

§ 371 Date: Jan. 5, 2007

(30) Foreign Application Priority Data
Jul. 12, 2004 (JP) 2004-205213

(51) Int. Cl. C08F 220/06; C04B 24/26

(52) U.S. Cl. 522/107

(57) ABSTRACT

The efficiency of production of the polycarboxylic acid type cement dispersant is exalted. Photo-polymerization is adopted in the production of the polycarboxylic acid type cement dispersant by polymerizing at least one kind of monomer represented by the chemical formula 1 and at least one kind of monomer represented by the chemical formula 2. A polymer composition having a small solvent content is obtained by causing the polymerization reaction to proceed under the condition of containing the monomers at a high concentration. Specifically, this invention is directed toward a method for producing a powdered polycarboxylic acid type cement dispersant, which method comprises a step of polymerizing the monomers under the condition of containing the monomers at a concentration of 50-100 mass % based on the total mss of the monomers and the solvent, a step of cooling the formed polymer thereby solidifying the polymer, and a step of pulverizing the solidified polymer.

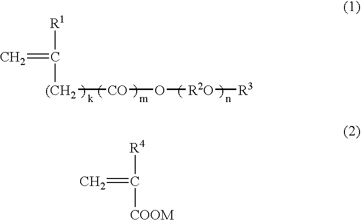

### TECHNICAL FIELD

This invention relates to a cement dispersant. More particularly, this invention relates to a method for the polymerization of a polycarboxylic acid type cement dispersant and a polycarboxylic acid type polymer excelling in properties necessary for a cement dispersant. Still more particularly, this invention relates to a method for the production of a powdered polycarboxylic acid type cement dispersant.

### BACKGROUND ART

The concrete has grown into one of the indispensable materials in the modern society and is now finding extensive utility in various applications directed toward buildings, houses, bridges, and tunnels. Generally, the concrete is formed by causing a concrete composition comprising cement, water, and an aggregate to set Besides these component materials, the concrete composition has incorporated therein various chemical admixtures which are intended to exalt various properties such as flow property and air entraining property of the concrete composition and freeze-drying property of the cured concrete composition.

As one of the chemical admixtures, the cement dispersant has been known. The amount of water incorporated in the concrete composition is preferred to be as small as permissible because the durability acquired by the concrete is increased in accordance as the amount of water contained therein decreases. If the amount of water incorporated is unduly small, however, the shortage will result in preventing the concrete composition from securing a necessary flowing property and compelling it to incur impairment of workability. The cement dispersant fulfills the function of decreasing the amount of water incorporated in the concrete composition and contributes to solve the problem of this water content.

As one kind of cement dispersant, the polycarboxylic acid type cement dispersant has been known. As a method for the production of the polycarboxylic acid type cement dispersant, the technique which consists in using a thermal polymerization initiator in an aqueous solution has been known (refer to U.S. Pat. No. 6,174,980B1 and U.S. Pat. No. 6,388,088B1, for example). In the production on the commercial level, however, the desirability of adopting a more efficient method of production and exalting the competitive power of the product has been finding growing recognition.

While the polycarboxylic acid type cement dispersant is generally used as a liquid product, it is preferred to be in a powdered form in consideration of the cost of transportation, for example.

As a method for producing the polycarboxylic acid type cement dispersant in the powdered form, a technique which resides in causing the aqueous solution containing a prescribed monomer to undergo a polymerization reaction and drying the aqueous solution containing the resultant polycarboxylic acid type polymer till the polymer is powdered (refer to US020020099115A1, US020040235687A1 and US020040242760A1, for example) has been known. As a means to dry the aqueous solution containing the polycarboxylic acid type polymer, the method of spray drying and the method of thin film drying have been disclosed. As an alternative means for such drying methods, a technique which resides in forming a thin film on a supporting member such as the drum drier, reducing the tenacity of the thin film, and subsequently powdering the thin film has been proposed (refer to U.S. Pat. No. 6,429,283B2, for example).

In the production on the commercial level, however, the desirability of adopting a more efficient method of production and exalting the competitive power of the product still has been finding growing recognition.

This invention is aimed at exalting the efficiency of the production of a polycarboxylic acid type polymer-containing cement dispersant and providing as well a novel polycarboxylic acid type polymer for a cement dispersant.

This invention has for another object thereof the provision of a means to produce a powdered polycarboxylic acid type cement dispersant efficiently.

### DISCLOSURE OF THE INVENTION

The objects of this invention mentioned above are accomplished by a method for producing a polycarboxylic acid type cement dispersant which comprises a step for polymerizing at least one kind of a monomer represented by the chemical formula 1 and at least one kind of a monomer represented by the chemical formula 2 by using a photo-polymerization initiator. 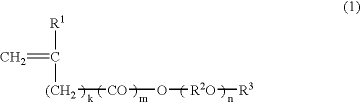
wherein R¹ denotes a hydrogen atom or a methyl group, R²O denotes an oxyalkylene group having a carbon number of 2-4, R³ denotes a hydrogen atom or a hydrocarbon group having a carbon number of 1-5, k denotes an integer of 0-2, m denotes 0 or 1, and n denotes an integer of 2-300 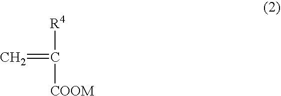
wherein R⁴ denotes a hydrogen atom or a methyl group and M denotes a hydrogen atom, a monovalent metal, a divalent metal, an ammonium group, or an organic amine group.

The objects mentioned above are also accomplished by a method for producing a powdered polycarboxylic acid type cement dispersant, which method comprises a step of polymerizing monomers under the condition that the concentration of the monomers based on the total mass of the monomers and a solvent is in the range of 50-100 mass %, a step of cooling the formed polymer and causing it to set, and a step of pulverizing the set polymer.

### BRIEF DESCRIPTION OF THE DRAWING

FIG. 1 is a type section illustrating a method for continuously producing a polycarboxylic acid type cement dispersant by using a belt moving in a horizontal direction and conveying monomers and a formed polymer.

### BEST MODE OF EMBODYING THE INVENTION

We have studied various means in search of a means to exalt the efficiency of production of a polycarboxylic acid type polymer for use in the cement dispersant and have discovered that use of photo-polymerization as a method of polymerization brings various unexpectable effects.

As one of the effects, the curtailment of the time for the reaction of polymerization can be cited. When the reaction of polymerization is promoted by using a thermal polymerization initiator, the time of polymerization tends to elongate. By promoting the reaction of polymerization by using a photo-polymerization initiator, however, it is made possible to shorten the time of polymerization comparatively.

As another of the effects, the increase of the monomer concentration during the course of polymerization can be cited. When the reaction of polymerization in an aqueous solution is promoted by using a thermal polymerization initiator, the increase of the monomer concentration results in broadening the molecular weight distribution of the produced polycarboxylic acid. When the polymer of a high molecular weight increases, the effect of coagulation is manifested to lower the dispersibility of cement. Conversely when the polymer of a low molecular weight increases, the cement ceases to adsorb this polymer of low molecular weight and incurs difficulty in manifesting the dispersibility because the polymer contains the carboxylic acid as an absorbent group only in a small amount. When the polymerization is effected by using a photo-polymerization initiator, the polymer possessing a sharp molecular weight distribution and excelling in the quality as a cement dispersant is obtained even if the reaction of polymerization is promoted in such a high concentration as 80 mass %, for example.

As yet another of the effects, the exaltation of the rate of reaction of the monomer may be cited. When the reaction of polymerization is promoted by using a photo-polymerization initiator, the polymer containing the unreacted monomer in a small amount is obtained. Then, by using the polycarboxylic acid type cement dispersant which has a small unreacted monomer content, it is made possible to repress the emission of offensive odor, prevent volatilizing compound, and improve the working atmosphere greatly.

Now, this invention will be described in detail below.

The first aspect of this invention is directed toward a method for the production of a polcarboxylic acid type cement dispersarit.

In the first method of production contemplated by this invention, at least one kind of monomer represented by the chemical formula 1 is used as one of the monomers necessary for the production.

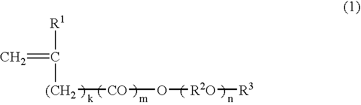

R¹ denotes a hydrogen atom or a methyl group.

R²O denotes an oxyalkylene group having a carbon number of 2-4 and preferably a carbon number of 2-3. As typical examples of the oxyalkylene group, oxyethylene (—CH₂CH₂O—), oxytrimethylene (—CH₂CH₂CH₂O—) oxytetramethylene (—CH₂CH₂CH₂CH₂O—), and oxypropylene (—CH₂CH(CH₃)O—, —CH(CH₃)CH₂O—) may be cited. When n is not less than 2, not less than two kinds of oxyalkylene group may be contained in the molecule. R²O is preferably oxyethylene in consideration of the dispersibility of the monomer in cement.

R³ denotes a hydrogen atom or a hydrocarbon group having a carbon number of 1-5 and preferably a hydrogen atom or a hydrocarbon group having a carbon number of 1-3, particularly an alkyl group. As typical examples of the hydrocarbon group having a carbon number of 1-5, methyl group, ethyl group, n-propyl group, iso-propyl group, sec-propyl group, n-butyl group, iso-butyl group, tert-butyl group, cyclobutyl group, n-pentyl group, and neopentyl group may be cited. R³ is preferably a hydrogen atom or a methyl group in consideration of the dispersibility of the monomer in cement.

k denotes the number of repetition of methylene (—CH₂—), which is an integer of 0-2. m denotes 0 or 1.

n denotes the number of repetition of R²O, which is an integer of 2-300. It is generally preferable to have incorporated in the monomer as many oxyalkylene groups as permissible with the object of enabling the monomer to manifest a high water-reducing ability. When the polymer obtained by the polymerization is dried to obtain a powdered polycarboxylic acid type cement dispersant, it is liable to dry more readily in accordance as the oxyalkylene group increases the length thereof. An attempt to incorporate the oxyalkylene group in a large amount, however, possibly renders it difficult to control the reaction of polymerization. In consideration of this fact, n denotes preferably an integer in the range of 2-100 and more preferably in the range of 50-100.

As typical examples of the monomer represented by the chemical formula 1, the esters of such polyalkylene glycols as polyethylene glycol mono(meth)acrylate, methoxy polyethylene glycol mono (meth)acrylate, ethoxypolyethylene glycol (meth)acrylate, methoxypolypropylene glycol mono(meth)acrylate, methoxypolyethylene glycol polypropylene glycol mono(meth)acrylate, methoxypolybutylene glycol mono(meth)acrylate, and methoxypolyethylene glycol polybutylene glycol mono (meth)acrylate with (meth) acrylic acid; and the alkylene oxide adducts of unsaturated alcohol obtained by adding 2-200 mols of an alkylene oxide to such unsaturated alcohols as allyl alcohol, methally alcohol, and 3-methyl-3-buten-1-ol may be cited. These monomers may be used in the form of a combination of two or more members.

The monomer represented by the chemical formula 1 may be a compound procured in the market or prepared by synthesis of the user's own accord. For the synthesis, the knowledge already acquired may be properly consulted. The ester of polyalkylene glycol with (meth)acrylic acid, for example, can be synthesized by the interesterification of the alkyl ester of such (meth)acrylic acid as methyl (meth)acrylate, ethyl (meth)acrylate, or propyl (meth)acrylate with a polyalokylene glycol. Then, the addition of an alkylene oxide to an unsaturated alcohol may be accomplished by adding such an alkylene oxide as ethylene oxide, propylene oxide, or butylene oxide to such an unsaturated alcohol as allyl alcohol, methallyl alcohol, or 3-methyl-3-buten-1-ol. Though the conditions for the addition of an alkylene oxide do not need to be particularly restricted, the addition is performed at a temperature preferably in the range of 800-155° C. and more preferably in the range of 90°-150° C.

In the first method of production contemplated by this invention, at least one kind of monomer represented by the chemical formula 2 is used as one of the monomers necessary for the production.

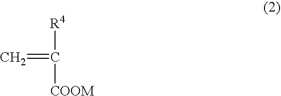

R⁴ denotes a hydrogen atom or a methyl group.

M denotes a hydrogen atom, a monovalent metal, a divalent metal, an ammonium group, or an organic amine group. As concrete examples of the monovalent metal, sodium and potassium may be cited. As typical examples of the divalent metal, calcium and magnesium may be cited. As typical examples of the organic amine group, monoethanolamine and triethanolamine may be cited. Preferably, the number of carbon atoms which the organic amine group contains is 1-5.

As typical examples of the compound represented by the chemical formula 2, acrylic acid, methacrylic acid, sodium acrylate, sodium methacrylate, ammonium acrylate, and ammonium methacrylate may be cited. These compounds may be used in the form of a combination of two or more members. The monomer represented by the chemical formula 2 may be a compound procured in the market or prepared synthetically of the user's own accord.

The monomer may be used, when necessary, in combination with other monomer. As typical examples of the other monomer, unsaturated dicarboxylic acids such as maleic acid, fumaric acid, itaconic acid, and citraconic acid; unsaturated sulfonic acids such as sulfoethyl (meth)acrylate, 2-methylpropane sulfonic acid (meth) acryl amide, and styrene sulfonic acid; unsaturated amides such as (meth)acryl amide and (meth) acryl alkyl amide; vinyl esters such as vinyl acetate and vinyl propionate; and aromatic vinyls such as styrene may be cited. The monovalent metal salts, divalent metal salts, ammonium salts, and organic amine salts of such other monomers may be also usable. These other monomers may be used in the form of a combination of two or more members.

A polycarboxylic acid type polymer which functions as a cement dispersant is produced by performing the reaction of polymerization using tow monomers mentioned above. In the method of production contemplated by this invention, photo-polymerization is utilized. Specifically, the reaction of polymerization is carried out by preparing a polymerization reaction system containing the monomers and a photo-polymerization initiator and exposing this system to a light which conforms to the photo-polymerization initiator.

The polymerization reaction system contains the monomers and the photo-polymerization initiator. The monomers comprise the monomer represented by the chemical formula 1 and the monomer represented by the chemical formula 2 and optionally contain other monomer. Though the compounding ratio of the monomer represented by the chemical formula 1 (monomer 1) and the monomer represented by the chemical formula 2 (monomer 2) does not need to be particularly restricted, the ratio of the mol number of the monomer 1/the mol number of the monomer 2 is preferably in the range of 1/1-1/10 and more preferably in the range of 1/2-1/7.

The photo-polymerization initiator does not need to be particularly restricted. As typical examples thereof, eutectic mixtures of 2-hydroxy-2-methyl-1-phenyl-propan-1-on, 2,2-dimethoxy-1,2-diphenylethan-1-on, 1-hydroxy-cyclohexyl-phenyl-ketone, or 1-hydroxy-cyclohexyl-phenyl-ketone with benzophenone, liquid mixtures of 2-hydroxy-2-methyl-1-phenyl-propan-1-on with 1-hydroxy-cyclohexyl-phenyl-ketone, mixtures of 1-[4-(2-hydroxyethoxy)-phenyl]-2-hydroxy-2-methyl-1-propan-1-on, 2-methyl-1[4-(methylthio)phenyl]-2-morpholinopropan-1-on, 2-benzyl-2-dimethylamino-1-(4-morpholinophenyl)-butanone-1, or bis(2,6-dimethoxybenzoyl)-2,4,4-trimethyl-pentyl-phosphine oxide with 2-hydroxy-2-methyl-1-phenyl-propan-1-on, mixture of bis(2,6-dimethoxybenzoyl)-2,4,4-trimethyl-pentyl-phosphine oxide with 1-hydroxy-cyclohexyl-phenyl-ketone, mixture of bis(2,6-dimethoxybenzoyl)-2,4,4-trimethyl-pentyl-phosphine on oxide with 1-hydroxy-cyclohexylphenyl-ketone, benzene ring-containing compounds such as bis(2,4,6-trimethylbenzoyl)-phenylphosphine oxide and bis(η⁵-2,4-cyclopentadien-1-yl)-bis(2,6-difluoro-3-(1H-pyrrol-1-yl)phenyl)titanium, and 2,2′-azobis(2-methylpropionamidine)-2-hydrochloride, and azo type polymerization initiator such as 2,2′-azobis(2-amidinopropane), 2,2′-azobis(N,N′-dimethylene isobutyl amidine), 2,2′-azobis[2-(5-methyl-2-imidazoline-2-il)propane], 1,1′-azobis(1-amidino-1-cyclopropylethane), 2,2′-azobis(2-amidino-4-methyl pentane), 2,2′-azobis(2-N-phenyl aminoamidino propane), 2,2′-azobis(1-imino-1-ethylamino-2-methyl propane), 2,2′-azobis(1-allylamino-1-imino-2-methyl butane), 2,2′-azobis(2-N-cyclohexyl amidino propane), 2,2′-azobis(2-N-benzyl amidino propane) and hydrocholic salt, sulfate salt and acetate salt thereof, 4,4′-azobis(4-cyanovaleic acid) and alkali metal salts, ammonium salts and amine salts thereof, 2-(carbamoyl azo) isobutylonitrile, 2,2′-azobis(isobutylamide), 2,2′-azobis[2-methyl-N-(2-hydroxyethyl)propionamide], 2,2′-azobis[2-methyl-N-(1,1′-bis(hydroxymethyl)ethyl) propionamide], 2,2′-azobis[2-methyl-N-1,1′-bis(hydroxy ethyl)propionamide], etc. may be cited. While the amount of the photo-polymerization initiator to be used may be properly controlled in conformity with the amount of the monomers to be used and the kind of photo-polymerization initiator, it is generally in the range of 0.01-5 mass %, preferably in the range of 0.1-3 mass %, and more preferably in the range of 0.1-1 mass %, based on the total amount of the monomers to be used.

The polymerization reaction system, when necessary, adds a solvent. The kind of this solvent does not need to be particularly restricted. As typical examples of the solvent, water; alcohols such as methyl alcohol, ethyl alcohol, and isopropyl alcohol; aromatic hydrocarbons such as benzene, toluene, and xylene; aliphatic hydrocarbons such as cyclohexane and -hexane; ester compounds such as ethyl acetate; and ketone compounds such as acetone and methylethyl ketone may be cited. Water and/or a lower alcohol having a carbon number of 1-4 is preferably used in consideration of the solubility or the monomers as the raw material and the produced polycarboxylic acid. Water is used more preferably in consideration of the advantage of omitting the step of removal of used solvent.

Since the method of production contemplated by this invention utilizes the reaction of photo-polymerization, it is capable of obtaining a polymer possessing a sharp molecular weight distribution and excelling in the quality for a cement dispersant even if the reaction of polymerization is performed under the condition using the monomers at high concentrations. For the purpose of making full use of this characteristic feature and realizing efficient production, the concentrations of the monomers are preferred to be as high as permissible. To be specific, the total concentration of the monomers based on the total mass of the monomers and a solvent is preferably in the range of 50-100 mass %, more preferably in the range of 60-100 mass %, and still more preferably in the range of 70-100 mass %. The statement that the monomer concentration is 100 mass % means that the reaction of polymerization is performed without the use of a solvent. Incidentally, the monomer concentration is the amount defined as the total mass of the monomer compounds based on the total mass of the compounds and the solvent which are added to the polymerization reaction system.

While the compounding ratio of the monomers does not need to be particularly restricted, the presence of a polyoxyalkylene in a certain extent proves favorable in consideration of the function as a cement dispersant. To be specific, the content of the monomer represented by the chemical formula 1 is preferably in the range of 10-50 mol % and more preferably in the range of 15-40 mol % based on the total mol number of the monomers and the content of the monomer represented by the chemical formula 2 is preferably in the range of 50-90 mol % and more preferably in the range of 60-85 mol % based on the total mol number of the monomers.

The polymerization time does not need to be particularly restricted but may be properly selected in conformity with the mode of polymerization reaction, the concentrations of the monomers, and the kinds of monomers. Since this invention utilizes the photo-polymerization, it allows the polymerization time to be shortened greatly as compared with the thermal polymerization.

The polymerization temperature does not need to be particularly restricted but is preferred to be in the range of 30°-80° C. Since the method of this invention adopts not thermal polymerization but photo-polymerization, it is capable of obtaining a polymer aimed at without heating the polymerization reaction system. Thus, the energy required for the polymerization reaction can be cut and the cost of production can be repressed.

The reaction of polymerization is initiated by exposing the polymerization reaction system to a light conforming to the photo-polymerization initiator. The method for effecting the exposure to this light does not need to be particularly restricted. The means of irradiation and the amount of irradiation may be decided on the basis of the knowledge already acquired.

The polymerization reaction of the monomers may be effected either batchwise or continuously. For the sake of commercial mass production, the adoption of a continuous operation proves more advantageous. When the continuous operation is adopted, the mode of operation does not need to be particularly restricted. For example, the continuous polymerization using an endless belt or the mode of continuously polymerizing a monomer solution passed inside a tube may suffice.

As the polymerization device used for the polymerization in accordance with the present invention, flat layer one can be adopted and it is not limited, if the temperature difference between the polymerization initiating temperature and maximum reaching temperature can be controlled within a specific range.

The thickness of the flat polymerization layer is usually in the range of 0.1-100 mm, preferably 0.5-70 mm, more preferably 1-50 mm. If the thickness exceeds 100 mm, control of the temperature becomes difficult, and heat accumulates in the inner film and hardening time of the polymer becomes longer. As the result, molecular weight and distribution of the molecular weight increase and productability decreases.

Although a material of the surface which contacts with composition is not limited, the material having good heat conductivity is preferable in order to improve the heat conductivity between the composition and the heating and cooling medium. Further, if the composition is acidic, the material which is difficult to corrode is preferable.

By the method described above, the polycarboxylic acid type polymer to be used as a cement dispersant is produced. The polycarboxylic acid type polymer which is obtained by the method of production contemplated by this invention possesses a sharp molecular weight distribution and excels in the quality as a cement dispersant. Further, the polymer thus obtained has a small unreacted monomer content.

The second aspect of this invention is directed toward a polycarboxylic acid type polymer for use in a cement dispersant, which polymer possesses a low unreacted monomer content and exhibits high dispersibility. To be specific, the second aspect of this invention comprises in a polycarboxylic acid polymer possessing repeated units originating in the monomer represented by the chemical formula 1 and repeated units originating in the monomer represented by the chemical formula 2, which polymer contains the monomer represented by the chemical formula 2 in a residual ratio of not more than 0.4 mass % and preferably not more than 0.3 mass % based on the total mass of the polymer, exhibits dispersibility of not more than 2.2 and preferably not more than 2.0, and befits the use for a cement dispersant.

If the residual amount of the monomer represented by the chemical formula is not less than 0.4%, there is possibility that odor generates, and operation environment becomes worse. According to the present invention, not only operability but also operation environment increase by decreasing residual ratio of the monomer under maintaining high dispersibility. Further, if the dispersion degree is not more than 2.2, effective component of the polymer moiety which shows dispersibility, and dispersibity. According to the present invention, by using the photo-polymerization initiator, the polymer having low dispersibility, high productibility and high dispersibility can be obtained, even in high concentration range wherein dispersibility can be obtained.

The polycarboxylic acid type polymer of the second aspect of this invention which functions as a cement dispersant can be produced by the method of production contemplated by the first aspect of this invention. The chemical formula 1 and the chemical formula 2 are as already described with respect to the first aspect of this invention and will be omitted from the following explanation.

The composition of the polycarboxylic acid polymer does not need to be particularly restricted so long as the compound represented by the chemical formula 1 and the compound represented by the chemical formula 2 are used as monomers therein. That is, the polycarboxylic acid type polymer of the second aspect of this invention for use in a cement dispersant possesses repeated units represented by the chemical formula 3 and the chemical formula 4.

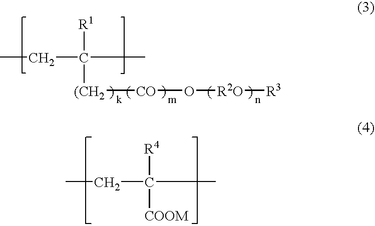

The definitions of R¹, R²O, R³, k, m, n, R⁴, and M are as already explained and will be omitted from the following explanation.

The constitutional unit represented by the chemical formula 3 corresponds to the structure having the polymerizing double bond of the monomer represented by the chemical formula 1 opened by the reaction of polymerization (the structure having the double bond (C═C) into a single bond (—C—C)). The constitutional unit represented by the chemical formula 4 corresponds to the structure having the polymerizing double bond of the monomer represented by the chemical formula 2 opened by the reaction of polymerization.

While the weight average molecular weight of the polycarboxylic acid type polymer does not need to be particularly restricted, it is preferably in the range of 5,000-200,000 and more preferably in the range of 10,000-100,000. The produced polymer acquires high water reducing property and slump loss preventing property more readily when the weight average molecular weight falls in the range specified above.

By using the polycarboxylic acid type polymer of a small unreacted monomer content as a cement dispersant, it is made possible to curb the emission of offensive odor originating in the cement dispersant, prevent the volatilized compound from exerting adverse effects on the organisms, and improve the working environment. The cement dispersant which contains the polycarboxylic acid type polymer having low dispersibility excels in such properties as water reducing property which are necessary for a cement dispersant. The polymer having a small unreacted monomer content and exhibiting low dispersibility is preferably produced by using photo-polymerization. By adopting the photo-polymerization, it is made possible to exalt the rate of reaction of the monomers, consequently ensure production of a polymer having a small unreacted monomer content, and elevate the degree of dispersion. For the calculation of the residual ratio of monomer and the calculation of the degree of dispersion, the techniques which will be described in the working examples below can be adopted.

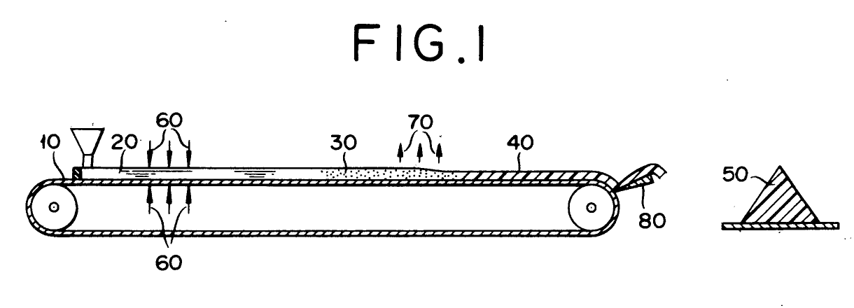

The production of the polycarboxylic acid type cement dispersant in a powdered state is preferred to be effected by the following method. For example, FIG. 1 is a type diagram illustrating a method for continuously producing a polycarboxylic acid type cement dispersant by the use of a belt moved in the horizontal direction for conveying the monomers and the produced polymer.

A composition 20 containing monomers is supplied to a belt 10 in motion in the horizontal direction. The composition 20 may contain other components such as a solvent and a polymerization initiator besides the monomers. The composition 20 thus supplied is conveyed by the motion of the belt 10. At a prescribed position, the composition 20 is exposed to light and heat in conformity with the kind of the polymerization initiator and made to undergo the reaction of polymerization. When the composition contains a photo-polymerization initiator as a polymerization initiator, the composition 20 being carried on the belt 10 in motion is generally exposed to the light emitted from above. When a photo-polymerization initiator and a thermal polymerization initiator are used in combination as a polymerization initiator, the composition 20 is exposed to the heat emanating from a heat source disposed around the composition 20 or inside the belt.

In the composition 20 carried on the belt 10, the reaction of polymerization advances and gives rise to a composition 30 containing a polycarboxylic acid type polymer capable of functioning as a cement dispersant. The form of this composition 30 varies with the concentration of monomers and the kind of produced polymer. It may be in the state of liquid or gel.

For the purpose of obtaining the polycarboxylic acid type cement dispersant in a powdered state, the polycarboxylic acid type cement dispersant must be solidified so as to be pulverized. When the composition 20 has a low monomer concentration in this case, the composition 30 containing the polycarboxylic acid type polymer contains the solvent such as water in a large amount. Thus, the removal o the water contained in the composition 30 necessitates a large amount of thermal energy. The consumption of the thermal energy in a large amount, however, causes the cost of production to increase. Further, the device and the process which are specially required for the removal of the solvent which is contained in a large amount likewise cause the cost of production to increase. Moreover, the heat used during the removal of the solvent entails such problems as deteriorating the polycarboxylic acid type polymer and degrading the quality of the polymer as a cement dispersant. In this respect, the method of production contemplated by this invention has a high monomer concentration in the composition 20 and, therefore, a small solvent content in the composition 30. Thus, it is capable of eliminating the problems mentioned above.

The solidification of the composition 30 can be accomplished by removing the solvent and subsequently cooling the composition. The method of production according to this invention is even capable of solidifying the composition 30 by cooling the composition 30 while omitting the removal of the solvent.

A powdered polycarboxylic acid type cement dispersant 50 is produced by pulverizing a polycarboxylic acid type monomer 40 which has been obtained by solidifying the composition 30. This invention is capable of producing the polycarboxylic acid type polymer 40 in such a form as to possess a certain degree of thickness as compared with the method which pulverizes a thin film as disclosed in U.S. Pat. No. 6,429,283B2. It is, therefore, capable of increasing the efficiency of production of the powdered polycarboxylic acid type cement dispersant and further capable of producing a cement dispersant by using a composition which incurs difficulty to form a thin film.

In the continuous production of the polycarboxylic acid type cement dispersant by the use of a belt which is moving in the horizontal direction, it is preferable to carry out the step of polymerizing the monomer and the step of solidifying the formed polymer continuously both on the belt conveying the monomers and the polymer with the object of conferring efficiency on the production. In the solidification of the composition 30 which contains a solvent in a large amount, since the removal of the solvent and the solidification of the polymer consume certain amounts of time, it has been difficult for the composition to reach the point of solidification while being conveyed on the belt. Since the method of production according to this invention is capable of solidifying the polymer comparatively easily by cooling, it enables the solidification of polycarboxylic acid type polymer to proceed while the polymer is being conveyed on the belt. By effecting the solidification of the polycarboxylic acid type polymer on the belt, it is made possible to simplify the devices for the drying and the cooling and decrease the floor area occupied by the equipment of production. Further, the solidification of the polycarboxylic acid can result in simplifying the work of collecting the polymer from the belt. Even when the devices for drying and cooling are installed separately of the polymerization device, the load exerted on these devices can be alleviated. Even when the polymer is solidified by spontaneous cooling, the time required for the cooling can be decreased and the efficiency of production can be enhanced.

Further, the powdered polycarbonic acid type polymer can be obtained by neutralizing the polymer loaded light 60 and/or heat 60 with sodium hydroxide, calcium hydroxide, etc. drying, hardening and pulverizing it. For example, a liquid polymer is obtained by loading light 60 and/or heat 60, and it is recovered once (the viscous liquid polymer is scraped by a scraper 80 and the like before hardening), it is transferred to a vessel provided blade or kneader, and it is neutralized by adding aqueous sodium hydroxide, calcium hydroxide, etc. under stirring, the base may be powder. After neutralization, the liquid polymer is returned on the belt, hardened and pulverized to obtain the powdered polycarboxilic acid type polymer.

In the present specification, this invention is explained mainly with respect to the continuous polymerization using the belt. In spite of this fact, the technical scope of this invention ought not to be regarded as limited to the belt polymerization. For example, the reaction of polymerization may be continuously carried out inside a tube which is used for conveying the monomers and the produced polymer. The polycarboxylic acid type cement dispersant may be produced by not continuous polymerization but batch polymerization. In consideration of the commercial mass production, however, the use of the continuous polymerization proves more advantageous.

In the continuous polymerization using a belt or a tube or in the batch polymerization, the apparatus to be used does not need to be particularly restricted in this invention but may be configured by properly consulting the knowledge already acquired. In the case of the continuous polymerization using a belt, for example, the knowledge disclosed in US020040110861A may be consulted.

Now, the method of production according to this invention will be explained in detail below by sequentially following the component steps of the process involved therein.

For a start, the composition 20 containing the monomers destined to form the raw materials for the polycarboxylic acid type cement dispersant is prepared. As the monomers, not less than one kind of monomer represented by the chemical formula 1 and not less than one kind of monomer represented by the chemical formula 2 are preferably used. The composition, when necessary, may use other monomer as mentioned above.

The composition 20 containing the monomers main contain a polymerization initiator. As the polymerization initiator, a photo-polymerization initiator may be used optionally in combination with a thermal polymerization initiator. Preferably, the photo-polymerization initiator is used. That is, by preparing the composition containing the monomers and the photo-polymerization initiator and exposing this composition to the light which is in conformity with the photo-polymerization initiator, the reaction of polymerization is enabled to proceed. The photo-polymerization initiator is as described above.

When the reaction of polymerization is made to proceed under the condition using the monomers at high concentrations as in this invention, it possibly results in broadening the molecular weight distribution of the produced polycarboxylic acid monomer and degrading the quality of the polymer as a cement dispersant. The present inventors have discovered that the polymerization using a photo-polymerization initiator constitutes an effective means to overcome the problem. When the polymerization is performed by using a photo-polymerization initiator, the polymer which possesses a sharp molecular weight distribution and excels in the quality as a cement dispersant is obtained even if the reaction of polymerization is made to proceed at such a high concentration as 80 mass %, for example.

As another effect of using a photo-polymerization initiator, the curtailment of the time spent for the reaction of polymerization may be cited. In the case of making the reaction of polymerization to proceed by using a thermal polymerization initiator, the polymerization time tends to elongate. By making the reaction of polymerization to proceed by using a photo-polymerization initiator, it is made possible to shorten the polymerization time comparatively. As a result, the solidification of the polycarboxylic acid type polymer can be made to proceed easily on the belt.

As yet another effect, the exaltation of the rate of reaction of the monomers may be cited. When the reaction of polymerization is made to proceed by using a photo-polymerization initiator, the polymer to be obtained has a small unreacted monomer content. Then, by using the polycarboxylic acid type cement dispersant having a small unreacted monomer content, it is made possible to curb the emission of offensive odor originating in the cement dispersant, prevent the volatilizing compound from exerting an adverse effects on the organisms, and improve the working environment.

The thermal polymerization initiator does not need to be particularly restricted. As typical examples of this initiator, cumene hydroperoxide, t-butyl hydroperoxide, dicumyl peroxide, di-t-butyl peroxide, benzoyl peroxide, lauroyl peroxide, potassium peroxide, and azobis-isobutyronitrile may be cited.

The amount of the thermal polymerization initiator to be used may be properly adjusted in conformity with the amounts of monomers to be used and the kind of polymerization initiator. This amount is generally in the range of 0.01-5 mass %, preferably in the range of 0.1-3 mass %, and more preferably in the range of 0.1-1 mass %, based on the total mass of the monomers to be used.

In the polymerization reaction system, when necessary, a solvent is added. The typical examples of the solvent are as described above.

The reaction of polymerization is initiated by adopting an appropriate measure in conformity with the polymerization initiator to be contained. When the composition has a photo-polymerization initiator incorporated therein, the composition containing the monomers is irradiated with a light having a prescribed wavelength. When the composition has a thermal polymerization initiator incorporated therein, the composition containing the monomers is heated.

The polymerization time does not need to be particularly restricted but may be properly selected in conformity with the mode of polymerization reaction, the concentrations of the monomers, and the kinds of monomers. When the photo-polymerization is adopted, the polymerization time can be widely decreased as compared with the thermal polymerization.

The polymerization temperature is controlled in conformity with the kinds of initiator and monomers to be used. Preferably, the reaction of polymerization is made to proceed at a low temperature by using a photo-polymerization initiator. The use of this initiator results in preventing the polycarboxylic acid type polymer from being deteriorated by the heat generated during the course of polymerization and, as well, decreasing the amount of thermal energy to be used. To be specific, the polymerization temperature is preferably in the range of 30°-80° C.

After the reaction of polymerization has proceeded, the composition containing the polymer is deprived of the solvent present therein. The method for the removal of the solvent does not need to be particularly restricted. The solvent may be removed by exposing the composition to an atmosphere of reduced pressure or may be forcibly dried by exposing the composition to a flow of hot air. When the composition containing the polymer is heated to effect forced removal of the solvent, it is preferable to pay attention lest the polymer be deteriorated by heat. In consideration of the simplification of the process involved and the deterioration of the polymer by heat, it is preferable to decrease the solvent content and eliminate the step for the removal of the solvent.

After the solvent has been removed or after the polymerization has been completed in the case of omitting the step for the removal of the solvent, the formed polymer is solidified by cooling. While the cooling means does not need to be particularly restricted, the technique of feeding cold air to the polymer may be adopted where the polymerization is made to proceed by using a belt. When the mode of making the reaction of polymerization to proceed inside a tube is adopted, the process of causing liquid drops containing the polymer to fall spontaneously from the tube and cooling the liquid drops in the course of spontaneous fall may be employed. Otherwise, the polymer may be cooled by causing such liquid drops released from the tube to fall onto a belt or a metal plate having a lower temperature than the liquid drops. The cooling temperature and the cooling time may be properly decided in conformity with the situation in which the polymer is solidified.

By pulverizing the solidified polymer, it is made possible to obtain the powdered polycarboxylic acid type cement dispersant. The means to pulverize the polymer does not need to be particularly restricted. As typical examples of the means available for the pulverization, high speed rotary crushers such as pin mill and hammer mill; screw mills such as coffee mill; and roll mills may be cited. The pulverizing means may be selected in conformity with the scale of production and the particle diameter to be expected.

The cement dispersant contemplated by this invention, similarly to known cement dispersants, is used as incorporated in a cement composition such as cement paste, mortar, or a concrete. It can be also used in a super-high strength concrete. The cement composition is capable of incorporating therein such materials as cement, water, fine aggregate, and coarse aggregate which are in popular use. Finely divided particles of fly ash, blast furnace slag, silica fume, and limestone may be incorporated in the cement composition. Incidentally, the term “super-high strength concrete” as used herein means what is generally so called in the field of cement composition, namely such a concrete as produces a cured mass of strength equivalent to or higher than the conventional countertype even when the water/cement ratio is decreased as compared with the conventional concrete. This concrete possesses workability incapable of hindering normal use even when the water/cement ratio is preferably not more than 25 mass %, more preferably not more than 20 mass %, still more preferably not more than 18 mass %, particularly preferably not more than 14 mass %, and most preferably in the neighborhood of 12 mass %. The compressive strength of the cured mass is preferably not less than 60 N/mm², more preferably not less than 80 N/mm², still more preferably not less than 100 N/mm², yet more preferably not less than 120 N/mm², particularly preferably not less than 160 N/mm², and most preferably not less than 200 N/mm².

As typical examples of the cement usable advantageously, portland cements of ordinary, high early strength, super high early strength, moderate heat, and white grades and mixed portland cements such as alumina cement, fly ash cement, blast-furnace cement, and silica cement may be cited. As regards the compounding amount of the cement per cubit meter (m³) of concrete and the unit water content, it is preferable to set the unit water content in the range of 100-185 kg/m³ and the water/cement ratio in the range of 10-70% for the purpose of producing a concrete of high durability and high strength. More preferably, the unit water content is in the range of 120-175 kg/m³ and the water/cement ratio in the range of 20-65%.

As regards the proportion of the amount of the cement dispersant of this invention to be added to the amount of the cement composition, the content of the polycarboxylic acid type polymer which is the essential component of this invention is preferably not less than 0.001 mass % and not more than 10 mass % based on the total amount of cement taken as 100 mass %. If this content falls short of 0.01 mass %, the shortage will possibly result in rendering the cement dispersant deficient in performance. If the content exceeds 10 mass %, the overage will possibly result in impairing the economy of production. The content is more preferably not less than 0.05 mass % and not more than 8 mass % and still more preferably not less than 0.1 mass % and not more than 5 mass %. The preceding mass % is the magnitude which is reduced to the solid content.

While the polycarboxylic acid type polymer is incorporated in the concrete composition, it is permissible to have not less than two kinds of polycarboxylic acid type polymer incorporated as a cement dispersant. The concrete composition may have other additives incorporated therein. For example, other cement dispersant, air entraining agent, cement wetting agent, expanding agent, waterproofing agent, retarding agent, accelerating agent, water-soluble macromolecular substance, thickening agent, coagulating agent, dry shrinkage reducing agent, strength promoting agent, hardness promoting agent, and defoaming agent may be incorporated.

As preferred modes of embodying the combination of the cement dispersant of this invention and other additives, the following items (1)-(7) may be cited.

(1) The combination having the two components, <1> the cement dispersant of this invention and <2> an oxyalkylene type defoaming agent as essential members. As the oxyalkylene type defoaming agent, polyoxyalkylenes, polyoxyalkylene alkyl ethers, polyoxyalkylene acetylene ethers, and polyoxyalkylene alkyl amines are available. Among other oxyalkylene type defoaming agents enumerated above, polyoxyalkylene alkyl amines prove particularly advantageous.

The compounding mass ratio of <2> the oxyalkylene type defoaming agent is preferred to be in the range of 0.01-20 mass % based on the mass of <1> the cement dispersant.

(2) The combination having the three components, <1> the cement dispersant of this invention, <2> an oxyalkylene type defoaming agent, and <3> an AE agent as essential members. As the oxyalkylene type defoaming agent, polyoxyalkylenes, polyoxyalkylene alkyl ethers, polyoxyalkylene acetylene ethers, and polyoxyalkylene alkyl amines are available. Among other oxyalkylene type defoaming agents enumerated above, polyoxyalkylene alkyl amines prove particularly advantageous. As the AE agent, fatty acid soaps, alkyl sulfuric acid esters, and alkyl phosphoric acid esters prove particularly advantageous. The compounding mass ratio of <2> the oxyalkylene type defoaming agent is preferred to be in the range of 0.01-20 mass % based on the mass of <1> the cement dispersant. The compounding mass ratio of <3> the AE agent is preferred to be in the range of 0.001-2 mass % based on the mass of cement.

(3) The combination having the three components, <1> the cement dispersant of this invention, <2> a copolymer formed of a polyalkylene glycol mono(meth)acrylic acid ester type monomer possessing a polyoxyalkylene chain adding alkylene oxides of a carbon atom number of 2-18 at an average addition mol number of 2-300, a (meth)acrylic acid type monomer, and a monomer copolymerizable with these monomers (described in JP-B-59-18338, US00000570744A, JP-A-9-241056, etc.), and <3> an oxyalkylene type defoaming agent, as essential members. The compounding mass ratio of the <1> cement dispersant and <2> the copolymer is preferably in the range of 5/95-95/5 and more preferably in the range of 10/90-90/10. The compounding mass ratio off <3> the oxyalkylene type defoaming agent is preferably in the range of 0.01-20 mass % based on the total mass of <1. The cement dispersant and <2> the copolymer.

(4) The combination having the two components, <1> the cement dispersant of this invention and <2> a retarding agent, as essential members. As typical examples of the retarding agent which is usable herein, oxycarboxylic acids such as gluconic acid (salt) and citric acid (salt), saccharides such as glucose, alcohols such as sorbitol, and phosphonic acids such as aminotri(methylene phosphinic acid) may be cited. The compounding mass ratio of <1> the cement dispersant and <2> the retarding agent is preferably in the range of 50/50-99.9/0.1 and more preferably in the range of 70/30-99/1.

(5) The combination having the two components, <1> the cement dispersant of this invention and <2> a promoting agent, as essential members. As typical examples of the promoting agent which is usable herein, soluble calcium salts such as calcium chloride, calcium nitrite, and calcium nitrate, chlorides such as iron chloride and magnesium chloride, thiosulfuric acid salts, and formates such as formic acid and calcium formate may be cited. The compounding mass ratio of <1> the cement dispersant and <2> the promoting agent is preferably in the range of 10/90-99.9/0.1 and more preferably in the range of 20/80-99/1.

(6) The combination having the two components, <1> the cement dispersant of this invention and <2> a material separation reducing agent, as essential members. As typical examples of the material separation reducing agent which is usable herein, various thickeners such as nonionic cellulose ethers and compounds possessing hydrophobic substituents formed of a hydrocarbon of a carbon atom number of 4-30 as a partial structure and polyoxyalkylene chains adding alkylene oxides of a carbon atom number of 2-18 at an average addition nol number of 2-300 may be cited. The compounding mass ratio of <1> the cement dispersant and <2> the material separation reducing agent is preferably in the range of 10/90-99.99/0.01 and more preferably in the range of 50/50-99.9/0.1. The cement composition of this combination is suitable as highly plasticized concrete, self-filling concrete, and self-leveling material.

(7) The combination having the two components, <1> the cement dispersant of this invention and <2> a sulfonic acid type dispersant possessing a sulfonic acid group in the molecular unit thereof, as essential members. As concrete examples of the sulfonic acid type dispersant which is usable herein, lignin sulfonic acid salts, naphthalene sulfonic acid formalin condensate, melamine sulfonic acid formalin condensate, polystyrene sulfonic acid salts, and aminosulfonic acid type dispersants such as aminoaryl sulfonic acid-phenol-formaldehyde condensate may be cited. The compounding mass ratio of <1> the cement dispersant and <2> the sulfonic acid type dispersant possessing a sulfonic acid group in the molecular unit thereof is preferably in the range of 5/95-95/5 and more preferably in the range of 10/90-90/10.

While the compounding amount of the polycarboxylic acid type polymer does not need to be particularly restricted, it is preferably in the range of 0.01-1.0 mass % and more preferably in the range of 0.02-0.5 mass %, based on the mass of cement. By having this polymer incorporated in an amount falling in this neighborhood, it is made possible to bring various favorable effects such as decreasing the unit water content, increasing the strength, and enhancing the durability.

The method for manufacturing the concrete composition does not need to be particularly restricted. The method heretofore adopted for the cement composition may be similarly used. For example, a method which consists in preparing a cement dispersant or a liquid containing the cement dispersant and put to use where cement, water, and optionally other compounding materials are mixed and a method which consists in preparatorily mixing cement, water, and optionally other compounding materials and subsequently adding a cement dispersant or a liquid containing the cement dispersant to the resultant mixture and mixing them together may be cited.

### EXAMPLE 1

A plastic container having an inside diameter of 5 cm and an inner volume of 250 ml was furnished with a silicone rubber stopper having fit therein a nitrogen introducing pipe, an exhaust pipe, and a thermometer. In the container, 33.0 g of purified water, 110.08 g of methoxy-polyethylene glycol monomethacrylate (PGM-25E) adding ethylene oxide as the monomer represented by the chemical formula 1 in an average addition mol number of 25 mols, 21.92 g of methacrylic acid (MMA) as the monomer represented by the chemical formula 2, 1.45 g of mercapto propionic acid as a chain transfer agent, and 1.52 g of 2-hydroxy-2-methyl-1-phenyl-propan-1-on (made by Ciba Specialty Chemicals K.K. and sold under the trademark designation of “Darocure”) as a photo-polymerization initiator were placed. The resultant mixed solution was continuously stirred with a magnetic stirrer and subjected to a treatment of displacement with nitrogen thoroughly till the dissolved oxygen content fell below 0.5 ppm. The concentration of the monomers in the solution was 80 mass % based on the total mass of the monomers and the solvent.

This solution was fed to a nitrogen-displaced polymerization vessel measuring 200 mm in diameter and made of polytetrafluoroethylene and irradiated with an ultraviolet light at a rate of 22 W/m² for 30 minutes to undergo a reaction of polymerization and give rise to a liquid copolymer (1) capable of functioning as a polycarboxylic acid type cement dispersant. The copolymer (1) had a weight average molecular weight of 19900 and a degree of dispersion of 1.95. When the residual methacrylic acid content of this copolymer was calculated based on the UV spectrum (determined at a wavelength of 230 nm) of the GPC, the residual ratio of methacrylic acid corresponding to the monomer represented by the chemical formula 4 was found to be 0.3 mass % based on the total mass of the copolymer. The results are shown in Table 1.

### EXAMPLE 2

A plastic container having an inside diameter of 5 cm and an inner volume of 250 ml was furnished with a silicone rubber stopper having fit therein a nitrogen introducing pipe, an exhaust pipe, and a thermometer. In the container, 33.0 g of purified water, 110.08 g of methoxypolyethylene glycol monomethacrylate (PGM-75E) adding ethylene oxide as the monomer represented by the chemical formula 1 in an average addition mol number of 75 mols, 21.92 g of methacrylic acid (MA) as the monomer represented by the chemical formula 2, 0.92 g of mercapto propionic acid as a chain transfer agent, and 1.52 g of 2-hydroxy-2-methyl-1-phenyl-propan-1-on (made by Ciba Specialty Chemicals K.K. and sold under the trademark of “Darocure”) as a photo-polymerization initiator were placed. The resultant mixed solution was continuously stirred with a magnetic stirrer and subjected to a treatment of displacement with nitrogen thoroughly till the dissolved oxygen content fall below 0.5 ppm. The concentration of the monomers in this solution was 80 mass % based on the total mass of the monomers and the solvent.

This solution was fed to a nitrogen-displaced polymerization vessel measuring 200 mm in diameter and made of polytetrafluoroethylene and irradiated with an ultraviolet light at a rate of 22 W/m² for 30 minutes to undergo a reaction of polymerization and give rise to a liquid copolymer (2) capable of functioning as a polycarboxylic acid type cement dispersant. The copolymer (2) had a weight average molecular weight of 65200 and a degree of dispersion of 2.63.

The produced polymer was exposed to hot air at 120° C. for 30 minutes to remove the water contained in the polymer. The polymer was cooled and solidified by being exposed to cold air. The solidified polymer was subsequently pulverized with a table mill at a rate of 15700 rpm for 30 seconds to give rise to a powdered polycarboxylic acid type cement dispersant (2).

The cement dispersant (2) was subjected to a mortar test with a view to view to studying the characteristic properties. The mortar was formed by compounding ordinary Taiheiyo portland cement (482 g), standard sand specified by JIS (Japanese Industrial Standard) R5201 (1350 g), and water (217 g). The mortar flow was produced by using a mixer and a kneading method specified in Article 10.4.3, titled “Kneading Method,” of JIS R5201 (1997) and put to use in the determination in conformity with “Flow Test” of JIS R5201 (1997). The conditions for the production of the cement dispersant (2) and the results of rating are shown in Table 2.

### EXAMPLE 3

In a device illustrated in FIG. 1, 33.0 g parts by weight per hour of purified water, 116.27 g parts by weight per hour of polyethylene glycol mono(3-methyl-3-butenyl)ether (IPN-50) adding ethylene oxide as the monomer represented by the chemical formula 1 in an average addition mol number of 50 mols, 15.51 g parts by weight per hour of acrylic acid (AA) as the monomer represented by the chemical formula 2, 0.90 g parts by weight per hour of mercapto propionic acid as a chain transfer agent, and 1.52 g parts by weight per hour of 2-hydroxy-2-methyl-1-phenyl-propan-1-on (made by Ciba Specialty Chemicals K.K. and sold under the trademark of “Darocure”) as a photo-polymerization initiator are placed. The resultant mixed solution is continuously stirred with a magnetic stirrer and subjected to a treatment of displacement with nitrogen thoroughly till the dissolved oxygen content fall below 0.5 ppm. The concentration of the monomers in this solution is 80 mass % based on the total mass of the monomers and the solvent.

This solution is fed to a nitrogen-displaced polymerization vessel measuring 200 mm in diameter and made of polytetrafluoroethylene and irradiated with an ultraviolet light at a rate of 22 W/m² for 30 minutes to undergo a reaction of polymerization and give rise to a copolymer (3) capable of functioning as a polycarboxylic acid type cement dispersant. The copolymer (3) had a weight average molecular weight of 28100 and a degree of dispersion of 2.28.

The produced polymer is exposed to hot air at 120° C. for 0.5 hour to remove the water contained in the polymer. The polymer is cooled and solidified by being exposed to cold air. The solidified polymer is subsequently pulverized with a table mill at a rate of 15700 rpm for 30 seconds to give rise to a powdered polycarboxylic acid type cement dispersant (3). The results are shown in Table 2.

The cement dispersant (3) is subjected to a mortar test by the same method as in Example 2 with a view to studying the characteristic properties. The conditions for the production of the cement dispersant (3) and the results of rating are shown in Table 2.

### EXAMPLE 4

A plastic container having an inside diameter of 5 cm and an inner volume of 250 ml was furnished with a silicone rubber stopper having fit therein a nitrogen introducing pipe, an exhaust pipe, and a thermometer. In the container, 66.77 g of polyethylene glycol mono(3-methyl-3-butenyl)ether (IPN-50) adding ethylene oxide as the monomer represented by the chemical formula 1 in an average addition mol number of 50 mols, 9.02 g of acrylic acid (AA) as the monomer represented by the chemical formula 2, 0.16 g of mercapto propionic acid as a chain transfer agent, and 1.52 g of 2-hydroxy-2-methyl-1-phenyl-propan-1-on (made by Ciba Specialty Chemicals K.K. and sold under the trademark designation of “Darocure”) as a photo-polymerization initiator were placed. The resultant mixed solution was continuously stirred with a magnetic stirrer and subjected to a treatment of displacement with nitrogen thoroughly till the dissolved oxygen content fell below 0.5 ppm. The concentration of the monomers in the solution was 100 mass % based on the total mass of the monomers and the solvent.

This solution was fed to a nitrogen-displaced polymerization vessel measuring 200 mm in diameter and made of Teflon® and irradiated with an ultraviolet light at a rate of 22 W/m² for 30 minutes to undergo a reaction of polymerization and give rise to a copolymer (4) capable of functioning as a polycarboxylic acid type cement dispersant. The copolymer (4) had a weight average molecular weight of 37000 and a degree of dispersion of 2.3. The produced polymer was cooled and solidified by being exposed to cold air. The solidified polymer was pulverized at a rate of 15700 rpm for 30 seconds to afford a powdered polycarboxylic acid type cement dispersant (4). The results are shown in Table 1.

<Control 1>

A glass reactor provided with a thermometer, a stirrer, a dropping funnel, a nitrogen introducing pipe, and a reflux condenser was charged with 100.02 g of purified water. The interior of the reactor was continuously stirred, displaced with nitrogen, and heated under an atmosphere of nitrogen to 80° C. After the internal temperature of the reactor was stabilized at 80° C., 169.98 g of an aqueous monomer solution resulting from mixing 112.59 g of PGM-25E as the monomer represented by the chemical formula 1, 22.41 g of MAA as the monomer represented by the chemical formula 2, 1.23 g of mercapto propionic acid as a chain transfer agent, and 33.75 g of purified water was added dropwise over a period of 4 hours and 30 g of an aqueous solution resulting from dissolving 1.55 g of ammonium persulfate as a thermal polymerization initiator was added dropwise over a period of 5 hours to the reactor. The concentration of the monomers in the resultant solution was 45 mass % based on the total mass of the monomers and the solvent. Subsequently, the resultant polymerization reaction solution was maintained at a temperature of 80° C. for one hour to complete the polymerization reaction. The resultant reaction solution was neutralized with sodium hydroxide to give rise to a liquid copolymer (1) for comparison capable of functioning as a polycarboxylic acid type cement dispersant. This copolymer (1) for comparison had a weight average molecular weight of 25100 and a degree of dispersion of 1.93. When the residual methacrylic acid content of this copolymer was calculated based on the UV spectrum (determined at a wavelength of 230 nm) of the GPC, the residual ratio of methacrylic acid corresponding to the monomer represented by the chemical formula 4 was found to be 0.5 mass % based on the total mass of the copolymer. The results are shown in Table 1.

<Control 2>

A glass reactor provided with a thermometer, a stirrer, a dropping funnel, a nitrogen introducing pipe, and a reflux condenser was charged with 178.83 g of PGM-25E as the monomer represented by the chemical formula 1, 35.60 g of MAA as the monomer represented by the chemical formula 2, 2.09 g of mercapto propionic acid as a chain transfer agent, and 53.61 g of purified water.

The interior of the reactor was continuously stirred, displaced with nitrogen, and heated under an atmosphere of nitrogen to 80° C. After the internal temperature of the reactor was stabilized at 80° C., 30 g of an aqueous solution having 1.55 g of ammonium persulfate dissolved therein as a thermal polymerization initiator was added dropwise to the reactor over a period of 5 hours. The concentration of the monomers in the resultant polymerization reaction solution was 71.5 mass % based on the total mass of the monomers and the solvent. Subsequently, the resultant polymerization reaction solution was maintained at a temperature of 80° C. for one hour to complete the polymerization reaction. The resultant reaction solution was neutralized with sodium hydroxide to give rise to a liquid copolymer (2) for comparison capable of functioning as a polycarboxylic acid type cement dispersant. This copolymer (2) for comparison had a weight average molecular weight of 26300 and a degree of dispersion of 2.24. When the residual methacrylic acid content of this copolymer was calculated based on the UV spectrum (determined at a wavelength of 230 nm) of the GPC, the residual ratio of methacrylic acid corresponding to the monomer represented by the chemical formula 4 was found to be 0.2 mass %. The results are shown in Table 1.

<Control 3>

A glass reactor provided with a thermometer, a stirrer, a dropping funnel, a nitrogen introducing pipe, and a reflux condenser was charged with 178.83 g of PGM-25E as the monomer represented by the chemical formula 1, 35.60 g of MAA as the monomer represented by the chemical formula 2, 2.09 g of mercapto propionic acid as a chain transfer agent, and 53.61 g of purified water.

The interior of the reactor was continuously stirred, displaced with nitrogen, and heated under an atmosphere of nitrogen to 80° C. After the internal temperature of the reactor was stabilized at 80° C.,

30 g of an aqueous solution having 1.55 g of ammonium persulfate dissolved therein as a thermal polymerization initiator was added dropwise thereto over a period of 1 hour. The concentration of the monomers in the resultant polymerization reaction solution was 71.5 mass % based on the total mass of the monomers and the solvent. Subsequently, the resultant polymerization reaction solution was maintained at a temperature of 80° C. for one hour to complete the polymerization reaction. The resultant reaction solution was neutralized with sodium hydroxide to give rise to a liquid copolymer (3) for comparison capable of functioning as a polycarboxylic acid type cement dispersant. Since the copolymer (3) for comparison had a polymerization ratio of only about 50%, it had a molecular weight too low to permit calculation of the weight average molecular weight and the degree of dispersion. When the residual methacrylic acid content of this copolymer was calculated based on the UV spectrum (determined at a wavelength of 230 nm) of the GPC, the residual ratio of methacrylic acid corresponding to the monomer represented by the chemical formula 4 was found to be 7.0 mass % based on the total mass of the copolymer. The results are shown in Table 1.

<Control 4>

A glass reactor provided with a thermometer, a stirrer, a dropping funnel, a nitrogen introducing pipe, and a reflux condenser was prepared. This reactor was charged with 22.01 g of purified water, 180.51 g of methoxypolyethylene glycol monomethacrylate (PGM-75E) adding ethylene oxide as the monomer represented by the chemical formula 1 at an average addition mol number of 75 mols, 35.93 g of methacrylic acid (MAA) as the monomer represented by the chemical formula 2, and 2.44 g of mercapto propionic acid as a chain transfer agent. The interior of the reactor was continuously stirred, displaced with nitrogen, and heated under an atmosphere of nitrogen to 80° C. After the internal temperature of the reactor was stabilized at 80° C., 27 g of an aqueous solution having 2.23 g of ammonium persulfate dissolved therein as a thermal polymerization initiator was added dropwise over a period of 5 hours. The concentration of the monomers in the resultant polymerization reaction solution was 80 mass % based on the total mass of the monomers and the solvent. Subsequently, the resultant polymerization reaction solution was maintained at a temperature of 80° C. for one hour to have the polymerization reaction proceed and give rise to a copolymer (4) for comparison capable of functioning as a polycarboxylic acid type cement dispersant. The copolymer (4) for comparison had a weight average molecular weight of 75600 and a degree of dispersion of 2.82.

The produced polymer was exposed to hot air at 120° C. for 0.5 hour to remove the water contained in the polymer. The polymer was cooled and solidified by being exposed to cold air. The solidified polymer was pulverized at a rate of 15700 rpm for 30 seconds to afford a powdered polycarboxylic acid type cement dispersant (4) for comparison. The results are shown in Table 2.

The cement dispersant (4) for comparison was subjected to a mortar test by the same method as in Example 1 with a view to studying the characteristic properties. The conditions for the production of the cement dispersant (4) for comparison and the results of rating are shown in Table 1.

<Control 5>

A plastic container having an inside diameter of 5 cm and an inner volume of 250 ml was furnished with a silicone rubber stopper stopper having fit therein a nitrogen introducing pipe, an exhaust pipe, and a thermometer. In the container, 132.0 g. of purified water, 27.52 g of methoxy polyethylene glycol monomethacrylate (PGM-75E) adding ethylene oxide as the monomer represented by the chemical formula 1 at an average addition mol number of 75 mols, 5.48 g of methacrylic acid 9MAA) as the monomer represented by the chemical formula 2, 0.23 g of mercapto propionic acid as a chain transfer agent, and 0.38 g of 2-hydroxy-2-methyl-1-phenyl-propan-1-on (made by Ciba Specialty Chemicals K.K. and sold under the trademark designation of “Darocure”) as a photo-polymerization initiator were placed. The resultant mixed solution was continuously stirred with a magnetic stirrer and subjected to a treatment of displacement with nitrogen thoroughly till the dissolved oxygen content fell below 0.5 ppm. The concentration of the monomers in the solution was 20 mass % based on the total mass of the monomers and the solvent.

This solution was fed to a nitrogen-displaced polymerization vessel measuring 200 mm in diameter and made of Teflon® and irradiated with an ultraviolet light at a rate of 22 W/m² for 30 minutes to undergo a reaction of polymerization and give rise to a copolymer (6) for comparison capable of functioning as a polycarboxylic acid type cement dispersant. The copolymer (5) for comparison had a weight average molecular weight of 73500 and a degree of dispersion of 2.72.

The produced polymer was exposed to hot air at 120° C. for 2 hours to remove the water contained in the polymer. The polymer was cooled and solidified by being exposed to cold air. The solidified polymer was pulverized with a table mill at 15700 rpm for 30 seconds to afford a powdered polycarboxylic acid type cement dispersant (5) for comparison. The results are shown in Table 1.

The cement dispersant (5) for comparison was subjected to a mortar test by the same method as in Example 2 with a view to studying the characteristic properties. The conditions for the production of the cement dispersant (5) for comparison and the results of rating are shown in Table 1.

<Control 6>

A glass reactor provided with a thermometer, a stirrer, a dropping funnel, a nitrogen introducing pipe, and a reflux condenser was prepared and charged with 149.6 g of purified water. The interior of this reactor was continuously stirred, subjected to a treatment of displacement with nitrogen, and heated under an atmosphere of nitrogen to 80° C. After the internal temperature of the reactor was stabilized at 80° C., 120.42 g of an aqueous monomer solution resulting from mixing 50.04 g of methoxy polyethylene glycol monomethacrylate (PGM-75E) adding ethylene oxide as the monomer represented by the chemical formula 1 at an average addition mol number of 75 mols, 9.96 g of methacrylic acid (MAA) as the monomer represented by the chemical formula 2, 0.42 g of mercapto propionic acid as a chain transfer agent, and 60.0 g of purified water was added over a period of 4 hours and 30 g of an aqueous solution having 0.69 g of ammonium persulfate dissolved therein was added over a period of 5 hours, both dropwise to the reactor. Subsequently, the temperature of the polymerization reaction solution was maintained at 80° C. for one hour to complete the polymerization reaction and give rise to a copolymer (6) for comparison capable of functioning as a polycarboxylic acid type cement dispersant. The copolymer (6) for comparison had a weight average molecular weight of 39200 and a degree of dispersion of 1.68.

The produced polymer was exposed to hot air at 120° C. for 2 hours to remove the water contained in the polymer. The polymer was cooled and solidified by being exposed to cold air. The solidified polymer was pulverized with a table mill at 15700 rpm for 30 seconds to afford a powdered polycarboxylic acid type cement dispersant (6) for comparison.

The cement dispersant (6) for comparison was subjected to a mortar test by the same method as in Example 2 with a view to studying the characteristic properties. The conditions for the production of the cement dispersant (6) for comparison and the results of rating are shown in Table

<Control 7>

A glass reactor provided with a thermometer, a stirrer, a dropping funnel, a nitrogen introducing pipe, and a reflux condenser was charged with 96.00 g of polyethylene glycol mono(3-methyl-3-butenyl)ether (IPN-50) adding ethylene oxide as the monomer represented by the chemical formula 1 at an average addition mol number of 50 mols. The interior of the reactor was continuously stirred, subjected to a treatment for displacement with nitrogen, and heated under an atmosphere of nitrogen to 70° C. After the internal temperature was stabilized at 70° C., 1.1 g of azobis-isobutyronitrile as a polymerization initiator was added thereto. Within 45 minutes of adding the polymerization initiator, 13.0 g of acrylic acid (AA) and 0.54 g of mercapto propionic acid as a chain transfer agent were collectively introduced into the reactor to make the polymerization reaction to proceed for 4.5 hours and give rise to a copolymer (7) for comparison capable of functioning as a polycarboxylic acid type cement dispersant. The copolymer (7) for comparison had a weight average molecular weight of 38000 and a degree of dispersion of 2.4. The results are shown in Table 1.

TABLE 1

| | | | | | | | Residual | |
|---|---|---|---|---|---|---|---|---|
| | | | Concentration | | | | ratio of | Drying |
| | | | of monomers | Method of | Polymerization | Degree of | monomer 2 | time |
| | Monomer 1 | Monomer 2 | (mass %) | polymerization | time (h) | dispersion | (mass %) | (h) |
| Example 1 | PGM-25E | MAA | 80 | Light | 0.5 | 1.95 | 0.3 | — |
| Example 2 | PGM-75E | MAA | 80 | Light | 0.5 | 2.63 | — | 0.5 |
| Example 3 | IPN-50 | AA | 80 | Light | 0.5 | 2.28 | — | 0.5 |
| Example 4 | IPN-50 | AA | 100 | Light | 0.5 | 2.3 | — | 0 |
| Control 1 | PGM-25E | MAA | 45 | Heat | 6 | 1.93 | 0.5 | — |
| Control 2 | PGM-25E | MAA | 71.5 | Heat | 6 | 2.24 | 0.2 | — |
| Control 3 | PGM-25E | MAA | 71.5 | Heat | 2 | — | 7.0 | — |
| Control 4 | PGM-75E | MAA | 80 | Heat | 6 | 2.82 | — | 0.5 |
| Control 5 | PGM-75E | MAA | 20 | Light | 0.5 | 2.72 | — | 2 |
| Control 6 | PGM-75E | MAA | 20 | Heat | 6 | 1.68 | — | 2 |
| Control 7 | IPN-50 | AA | 100 | Heat | 4.5 | 2.4 | — | — |

The comparison of Example 1 and Controls 1 and 3 clearly reveals that the adoption of the photo-polymerization reaction using a photo-polymerization initiator results in widely shortening the polymerization time. It is clear from the comparative examples that the decrease of the polymerization time in the thermal polymerization results in preventing the ratio of polymerization from rising and greatly increasing the amount of the residual methacrylic acid. When the polymerization is made to proceed at a high concentration, the polymer synthesized b thermal polymerization suffers the degree of dispersion to rise (Controls 2, 4, and 7). In contrast, when the photo-polymerization reaction is adopted, the produced polymer acquires a low degree of dispersion (Example 1). The polymer obtained by the photo-polymerization (Examples 1, 2, and 4) has a smaller residual amount of monomer than the polymer obtained by the thermal polymerization. By adopting the photo-polymerization reaction, it is made possible to shorten the polymerization time widely, narrow the molecular weight distribution even when the polymerization is effected at a high concentration, and allow the produced polymer to possess only a small residual monomer content.

As regards the pulverization, the comparison of examples 2 and 3 and comparative examples 5 and 6 clearly reveals that by making the polymerization reaction to proceed under the condition of a high monomer concentration, it is made possible to alleviate the labor and time spend in the removal of the solvent from the produced polymer. Further, example 4 demonstrates that the cost of production can be widely cut because the production allows the pulverization to be effected without requiring a drying device.

<Conditions of determination>

(Weight Average Molecular Weight)

Kind of device: Waters LCM1

Detector: Waters differential diffraction indicator 410

Analysis software: Waters Millennium Ver. 2.18

Eluting solution: An eluting solution obtained by dissolving 115.6 g of sodium acetate trihydrate in a mixed solution of 10999 g of water and 6001 g of acetonitrile and adjusting the produced solution with an aqueous 30% sodium hydroxide solution to pH 6.

Flow rate of eluting solution: 0.8 ml/min.

Column temperature: 35° C.

Column: TSK gel Guard Column SWXL+G4000SWXL+G3000SWXL+G2000SWXL made by Toso K.K.

Standard substance: Polyethylene glycol, weight average molecular weight (Mw) 272500, 219300, 85000, 46000, 24000, 12600, 2550, 7100, 1470

(Degree of Dispersion of Copolymer)

The degree of dispersion of a given sample was determined by assaying this sample with the molecular weight determining device (LCM1) mentioned above, calculating the weight average molecular weight (Mw) and the number averae molecular weight (Mn) by using the analysis software mentioned above, and finding the ratio Mw/Mn.

(Residual Ratio of Monomer Represented by the Chemical Formula 2)

The UV intensity of a wavelength of 230 nm was measured by using a UV measuring unit (UV/VIS detector of model 486) annexed to the molecular weight determining device (LCM1) mentioned above. Several MAA samples of varying concentrations were analyzed to prepare a calibration curve. The residual ratio was determined by finding the residual amounts of MAA in the total sum of polymer based on the calibration curve.

<Mortar Test>

The copolymer (1), the copolymer (3) for comparison, and the copolymer (4) for comparison were subjected to the mortar test with a view to studying the characteristic properties of the polycarboxylic acid type cement dispersant of this invention as a cement dispersant.

The mortar composition was as follows.

(Mortar Formulation 1)

Taiheiyo ordinary portland cement: 482 g

Standard sand specified in JIS R5201: 1350 g

Water: 217 g

The flow test specified in JIS R5201 (1997) was performed by using a mixer and a kneading method conforming to the Kneading Method specified in Item 10.4.3 of JIS R5201 (1997). The results are shown in Table 2.

TABLE 2

| | | | Concentration | | | Amount | Mortar | Amount |
|---|---|---|---|---|---|---|---|---|
| | | | of monomer | Method of | Degree of | added | flow | of air |
| | Monomer 1 | Monomer 2 | (mass %) | polymerization | dispersion | (wt %/° C.) | (mm) | (vol %) |
| Example 1 | PGM-25E | MAA | 80 | Light | 1.95 | 0.08 | 231 | 9.0 |
| Example 2 | PGM-75E | MAA | 80 | Light | 2.63 | 0.08 | 193 | 5.1 |
| Example 3 | IPN-50 | AA | 80 | Light | 2.28 | 0.08 | 180 | 3.0 |
| Example 4 | IPN-50 | AA | 100 | Light | 2.3 | 0.08 | 179 | 3.2 |
| Control 1 | PGM-25E | MAA | 45 | Heat | 1.93 | 0.08 | 218 | 8.0 |
| Control 2 | PGM-25E | MAA | 71.5 | Heat | 2.24 | 0.08 | 214 | 8.0 |
| Control 3 | PGM-25E | MAA | 71.5 | Heat | — | 0.08 | 183 | 7.5 |
| Control 4 | PGM-75E | MAA | 80 | Heat | 2.82 | 0.08 | 183 | 4.6 |
| Control 5 | PGM-75E | MAA | 20 | Light | 2.72 | 0.08 | 195 | 3.5 |
| Control 6 | PGM-75E | MAA | 20 | Heat | 1.68 | 0.08 | 171 | 4.2 |
| Control 7 | IPN-50 | AA | 100 | Heat | 2.4 | 0.08 | 173 | 3.1 |

As shown in Table 2, the comparison of examples 1, 2, and 4 and Controls 2, 4, and 7 clearly reveals that the adoption of the photo-polymerization enables the produced polymer to possess a low degree of dispersion even under the condition of a high monomer concentration. That is, by this adoption, the polymer excelling in characteristic properties as a cement dispersant is enabled to be produced efficiently.

### INDUSTRIAL APPLICABILITY

In accordance with this invention, the adoption of the photo-polymerization reaction enables the polycarboxylic acid type cement dispersant to be produced efficiently in a short period of time. By performing the polymerization reaction under the condition of a high monomer concentration, it is made possible to obtain the polymer having a small water content. Thus, by drying the produced polymer, it is made possible to alleviate the time and labor required for the production of a powdered polycarboxylic acid type cement dispersant and enhance the efficiency of production as well.

1. A method for the production of a polycarboxylic acid type cement dispersant, which comprises a step polymerizing at least one kind of monomer represented by the chemical formula 1 and at least one kind of monomer represented by the chemical formula 2 by using a photo-polymerization initiator. 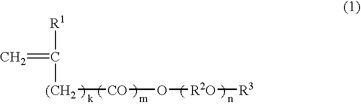
wherein R¹ denotes a hydrogen atom or a methyl group, R²O denotes an oxyalkylene group having a carbon number of 2-4, R³ denotes a hydrogen atom or a hydrocarbon group having a carbon number of 1-5, k denotes an integer of 0-2, m denotes 0 or 1, and n denotes an integer of 2-300, and 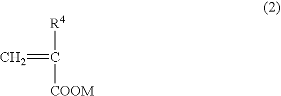
wherein R⁴ denotes a hydrogen atom or a methyl group and M denotes a hydrogen atom, a monovalent metal, a divalent metal, an ammonium group, or an organic amine group.

2. A method according to claim 1, wherein the polymerization reaction is carried out in a solvent.

3. A method according to claim 1, wherein n in the chemical formula 1 denotes an integer of 2-100.

4. A method according to claim 1, wherein the concentration of the monomers is in the range of 50-100 mass % based on the total mass of the monomers and the solvent.

5. A method according to claim 1, wherein the polymerization temperature is in the range of 30°-80° C.

6. A method according to claim 1, wherein the content of the monomer represented by the chemical formula 1 is in the range of 10-50 mol % based on the total mol of the monomers and the content of the monomer represented by the chemical formula 2 is in the range of 50-90 mol % based on the total mol of the monomers.

7. A method according to claim 1, wherein R²O denotes an oxyalkylene group of a carbon number of 2-3 and R³ denotes a hydrogen atom or an alkyl group of a carbon number of 1-3 in the chemical formula 1.

8. A method according to claim 1, which comprises
a step of polymerizing the monomers under the condition of having the concentration of the monomers in the range of 50-100 mass % based on the total sum of the monomers and the solvent,
a step of cooling the formed polymer thereby solidifying the polymer, and
a step of pulverizing the solidified polymer.

9. A method according to claim 8, wherein the step of performing the polymerization and the step of solidifying the polymer are continuously carried out on a belt which is conveying the monomers and the polymer mentioned above.

10. A polycarboxylic acid type polymer for use as a cement dispersant, comprising a repeated unit originating in the monomer represented by the chemical formula 1 and a repeated unit originating in the monomer represented by the chemical formula 2, having the unreacted portion of the monomer represented by the chemical formula 2 at a ratio of not more than 0.4 mass % based on the total mass of the polymer, and possessing the degree of dispersion of not more than 2.2, 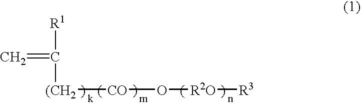
wherein R¹ denotes a hydrogen atom or a methyl group, R²O denotes an oxyalkylene group having a carbon number of 2-4, R³ denotes a hydrogen atom or a hydrocarbon group having a carbon number of 1-5, k denotes an integer of 0-2, m denotes 0 or 1, and n denotes an integer of 2-300, and 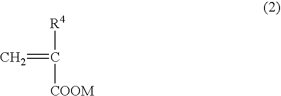
wherein R⁴ denotes a hydrogen atom or a methyl group and M denotes a hydrogen atom, a monovalent metal, a divalent metal, an ammonium group, or an organic amine group.

11. A polymer according to claim 10, wherein n denotes an integer of 2-100 in the chemical formula 1.

12. A polymer according to claim 10, wherein R²O denotes an oxyalkylene group having a carbon number of 2-1 and R³ denotes a hydrogen atom or an alkyl group of a carbon number of 1-3 in the chemical formula 1.

13. A polymer according to claim 10, wherein the weight average molecular weight is in the range of 5,000-200,000.

14. A method according to claim 2, wherein n in the chemical formula 1 denotes an integer of 2-100.

15. A method according to claim 2, wherein the concentration of the monomers is in the range of 50-100 mass % based on the total mass of the monomers and the solvent.

16. A method according to claim 3, wherein the concentration of the monomers is in the range of 50-100 mass % based on the total mass of the monomers and the solvent.

17. A method according to claim 2, wherein the polymerization temperature is in the range of 30°-80° C.

18. A method according to claim 3, wherein the polymerization temperature is in the range of 30°-80° C.

19. A method according to claim 4, wherein the polymerization temperature is in the range of 30°-80° C.

20. A method according to claim 2, wherein the content of the monomer represented by the chemical formula 1 is in the range of 10-50 mol % based on the total mol of the monomers and the content of the monomer represented by the chemical formula 2 is in the range of 50-90 mol % based on the total mol of the monomers.
